(19) United States
(12) Patent Application Publication
(10) Pub. No.: US 2026/0074490 A1
(43) Pub. Date: Mar. 12, 2026

(54) Universal Meter Box Hub

(71) Applicant: Halex Electric Company, Harrison, OH (US)

(72) Inventors: Macario Santana GONZALEZ, Addyston, OH (US); Joshua Stephen SACKETT, Dayton, OH (US); David Vaughn McELVEEN, II, Fort Wayne, IN (US); Randal Charles MOSS, Concinnati, OH (US)

(73) Assignee: Halex Electric Company, Harrison, OH (US)

(21) Appl. No.: 19/323,695

(22) Filed: Sep. 9, 2025

Related U.S. Application Data
(60) Provisional application No. 63/692,326, filed on Sep. 9, 2024.

(51) Int. Cl. H02B 1/03

(52) U.S. Cl. CPC H02B 1/03

(57) ABSTRACT

A meter box hub for use with meter boxes having different layouts of pre-drilled holes is described herein. The meter box includes a base with a flanged portion and an engaging body portion formed of side walls extending away from the flanged portion. The base is configured to be placed against an outer surface of enclosure having a set of holes in one of multiple possible layouts. The side walls of the engaging body portion define an opening via which the hub is configured to receive a conduit at an end of the engaging body portion opposite the base. The interior surface of the sides walls includes a threaded portion configured to engage the conduit. The flanged portion includes slots configured to receive fasteners to removably attach the hub to the enclosure. The slots are elongated and arranged to accommodate each of the multiple possible layouts.

### RELATED APPLICATIONS

This application claims priority to U.S. Provisional Ser. No. 63/692,326, filed Sep. 9, 2024, the content of which is incorporated herein by reference in its entirety.

### FIELD OF THE INVENTION

The present invention relates to electrical equipment and, more particularly, to a universal hub for use on meter boxes and other types of electrical boxes.

### BACKGROUND OF THE INVENTION

Meter boxes are enclosures that house a number of electrical components, such as the meter itself, a main switch, fuses, and circuit breakers, which control the flow of electricity into a building or structure. Meter box hubs are frequently installed on such enclosures to connect and form a watertight seal between conduit housing electrical supply wires and the meter box. However, individual meter boxes may require different meter box hubs based on the size of the meter box and the position and layout of pre-drilled holes configured to receive screws or bolts to attach the meter box hub to the meter box. The threads on conventional meter box hubs can also be difficult to engage, while also being prone to cross threading.

A meter box hub that accommodates a wide range of meter box sizes with threading that aids in installation while reducing the occurrence of cross threading would represent a significant improvement over conventional meter box hubs.

### SUMMARY OF THE INVENTION

Aspects of this disclosure relate to a hub for use with meter boxes having different layouts of pre-drilled holes. For example, the meter box hub described herein may be installed on a wide range of meter box configurations, for one-size-fits-all installations. The hub described herein comprises a base with a flanged portion and an engaging body portion formed of side walls extending away from the flanged portion. In various embodiments, the enclosure, which may comprise a meter box or other type of electrical box, includes a set of holes arranged in one of two or more layouts. The base is configured to be placed against an outer surface of enclosure having the set of holes—specifically, whichever of the sides of the enclosure having the set of holes. As described herein, an interior surface of the side walls of the engaging body portion defines an opening via which the hub is configured to receive a conduit at an end of the engaging body portion opposite the base. In various embodiments, the engaging body portion is substantially cylindrical. As such, the opening defined by the interior surface of the side walls may similarly be substantially cylindrical. The interior surface includes a threaded portion configured to engage a reciprocal threaded portion of the conduit. In some embodiments, the threaded portion may include a blunt start thread. In various embodiments, the flanged portion includes a plurality of slots configured to receive fasteners to removably attach the hub to the enclosure. The plurality of slots are elongated and arranged to accommodate each of the two or more layouts. In some embodiments, the plurality of slots include at least a first set of slots positioned proximate a first outer edge of the base and a second set of slots positioned proximate a second outer edge of the base. In some embodiments, the plurality of slots includes at least four slots, wherein the first set of slots includes two slots, and the second set of slots includes two slots. In some such embodiments, the first set of slots may comprise elongated apertures positioned parallel to each other and the first outer edge of the base, and the second set of slots may comprise elongated apertures pointing towards a center of the opening defined by the interior surface of the side walls. In some embodiments, an exterior surface of the side walls may include a threaded portion proximate the end of the engaging body portion opposite the base.

Aspect of this disclosure also relate to a meter box system comprising a meter box including at least four apertures arranged in one or more rectangular configurations and a hub including a centralized aperture for receiving a conduit housing electrical supply wires and a means for coupling the hub to the meter box via the at least four apertures.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a perspective view of an example universal meter box hub, according to one or more aspects described herein;

FIG. 2 depicts a perspective view of an example installation of a universal meter box hub described herein on an enclosure, according to one or more aspects described herein;

FIGS. 3A-C depict various views of an example universal meter box hub, according to one or more aspects described herein; and

FIG. 4 depicts another cross-sectional view of an example universal meter box hub, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. These aspects are indicative, however, of but a few of the various ways in which the principles of the invention may be employed and the present invention is intended to include all such aspects and their equivalents. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

A universal meter box hub configured to be installed on a wide range of meter box configurations, for one-size-fits-all installations, is disclosed herein. In various implementations, the universal meter box hub described herein may include one or more slots positioned on a flanged portion of the body of the meter box hub that are configured to receive screws or bolts used to install the universal meter box hub on an enclosure, regardless of varying positions and/or layouts of the holes on the enclosure configured to receive those screws or bolts. In various implementations, the universal meter box hub described herein may also include a threaded portion configured to provide easy and enhanced engagement of a conduit, while also reducing the risk of cross-threading or damage to the threads or the conduit. For example, in some implementations, the threaded portion of the universal meter box hub may utilize a blunt start thread.

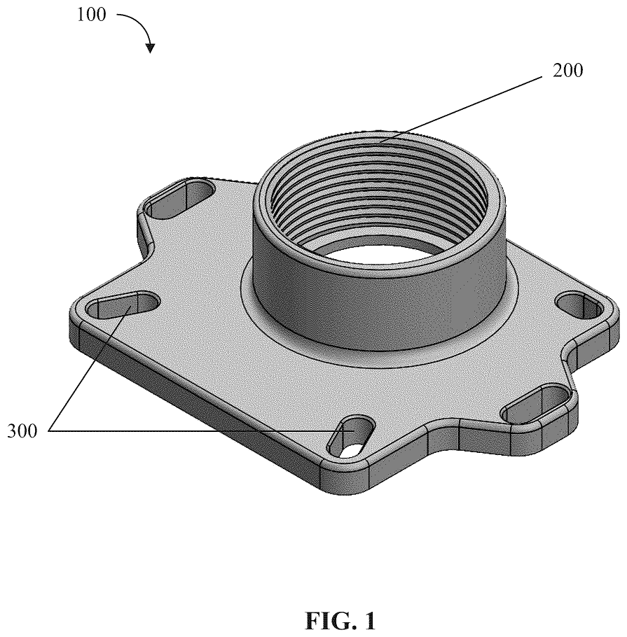

FIG. 1 depicts a perspective view of example universal meter box hub 100, according to one or more aspects described herein. In various embodiments, universal meter box hub 100 may include an opening 200, one or more slots 300 and/or one or more other components. In various embodiments, an interior of opening 200 may comprise a threaded portion. In various embodiments, the threaded portion may comprise a thread profile configured to facilitate easier engagement of a conduit with opening 200. For example, in some embodiments, the thread profile of the threaded portion of opening 200 may comprise a blunt start thread. A blunt start thread (as defined by The American Society of Mechanical Engineers specification (ASME) B1.7-2006, also known as a Higbee or a convoluted thread) is a type of thread that includes a specific cut added to a beginning of a thread to produce a blunt start. In various embodiments, a thread profile of the threaded portion of opening 200 may comprise a blunt start thread that begins with a gradual increase in thread height until it reaches its full profile. This is achieved by truncating or removing the initial part of the thread. In contrast, a standard thread has a uniform profile extending from the starting edge to the end. Blunt start threads also reduce the risk of cross-threading. Blunt start threads also provide an alignment feature, helping ensure the component being received (e.g., a screw or bolt or, in this case, a conduit) enters the mating thread properly and reduces the likelihood of misalignment. Because of the smoother engagement, there is also generally less initial resistance, which means less torque to engage the threads. This can reduce operator fatigue and improve installation efficiency. Blunt start threads can also protect the first few threads from damage, which is important in maintaining the integrity of the fastening.

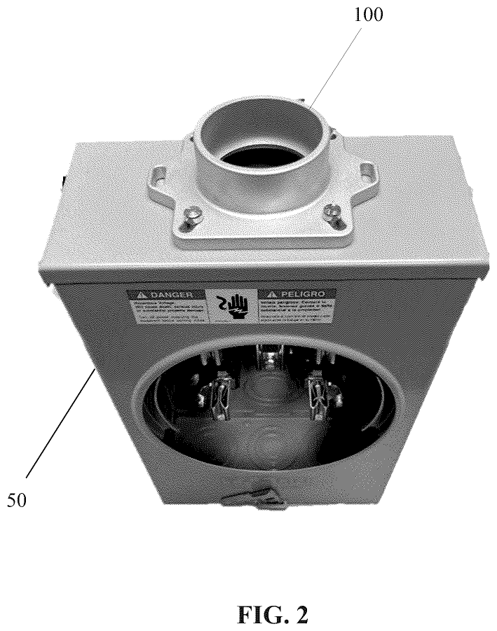

FIG. 2 depicts a perspective view of an example installation of universal meter box hub 100 on an enclosure 50, according to one or more aspects described herein. In various embodiments, universal meter box hub 100 may be installed on (removably attached to) an enclosure at an opening on top of the enclosure. For example, universal meter box hub 100 may be installed on a top side of an enclosure 50, such as a meter box, as depicted in FIG. 2. In some embodiments, enclosure 50 may be configured to receive cables, pipes, and/or other components via an opening on a top (as depicted in FIG. 2), bottom, front, back, or side of enclosure 50. In various embodiments, universal meter box hub 100 may be installed at said opening and used to connect conduit housing electrical supply wires to enclosure 50. In various implementations, enclosure 50 may include pre-drilled holes configured to receive screws or bolts to attach a meter box hub to enclosure 50. In other implementations, holes configured to receive screws or bolts to attach a meter box hub to enclosure 50 may be drilled during installation. In various implementations, one or more slots 300 of universal meter box hub 100 may be configured to be installed on various types of enclosures, including enclosures of varying sizes and/or enclosures with holes in different positions and having different layouts.

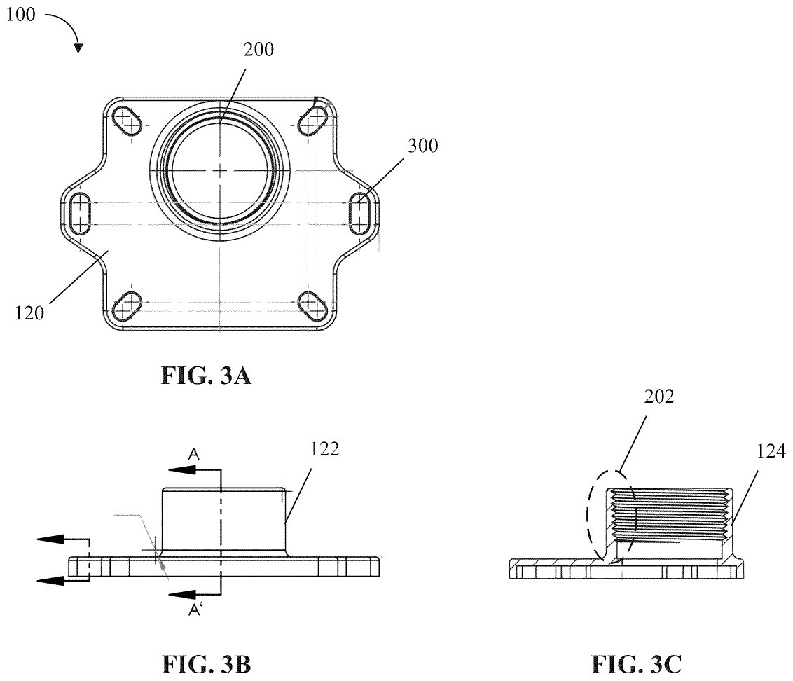

FIGS. 3A-C depict various views of example universal meter box hub 100, according to one or more aspects described herein. For example, FIG. 3A depicts a top view of universal meter box hub 100, FIG. 3B depicts a side view of universal meter box hub 100, and FIG. 3C depicts a cross-sectional view of universal meter box hub 100 as depicted in FIG. 3B along a line A-A′. As described herein, universal meter box hub 100 may include an opening having a threaded portion, and one or more slots 300 (as depicted in FIG. 3A) configured to allow universal meter box hub 100 to be installed on an enclosure 50 (as depicted in FIG. 2). In various embodiments, universal meter box hub may comprise a base with a flanged portion 120 configured to be placed against (and, thus, substantially parallel to) a side of an enclosure 50 to which universal meter box hub 100 is being installed. In various embodiments, an engaging body portion 122 may extend away from flanged portion 120. In various embodiments, engaging body portion 122 may be substantially cylindrical and formed of side walls 124, which define the opening 200 described herein. In various embodiments, the threaded portion 202 of opening 200, described herein with respect to FIG. 1, may be located on an interior side of side walls 124.

In various embodiments, one or more slots 300 may be positioned within the flanged portion 120 of the base of universal meter box hub 100. In various embodiments, one or more slots 300 may have an elongated shape with circular edges (as depicted in FIG. 3A) so as to receive bolts or screws configured to affix universal meter box hub 100 to a meter box (or other enclosure 50). In other embodiments, however, the one or more slots 300 of universal meter box hub 100 may be a non-circular, rectangular, polygonal, triangular, oval, or any other combination of appropriate shapes without departing from the scope of the invention described herein.

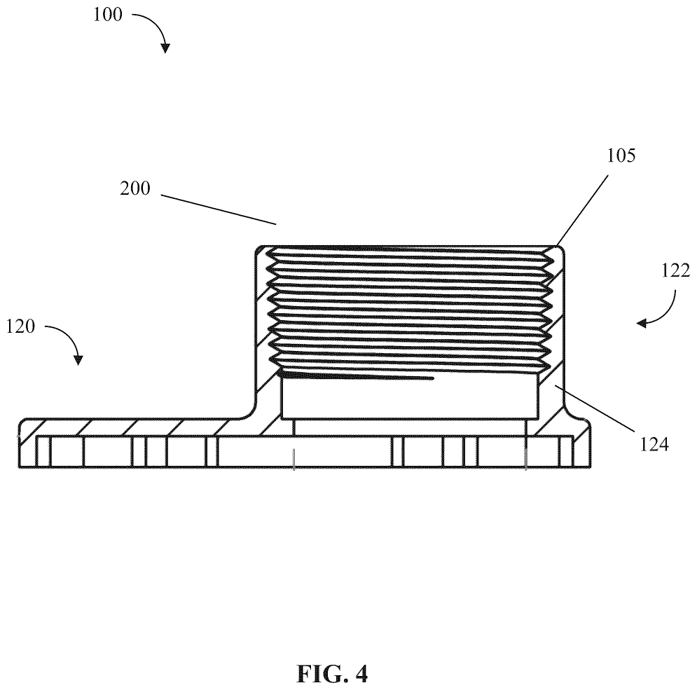

FIG. 4 depicts another cross-sectional view of example universal meter box hub 100, according to one or more aspects described herein. As described herein, universal meter box hub 100 may include a flanged portion 120 having one or more slots 300 (not shown in FIG. 4), an engaging body portion 122 having side walls 124, and/or one or more other components. In various embodiments, the one or more slots 300 may comprise mounting holes configured to receive bolts, screws, and/or other types of fasteners used to secure universal meter box hub 100 to an enclosure. For example, the one or mounting holes may be configured to receive bolts, screws, and/or other types of fasteners used to removably attach universal meter box hub 100 to an enclosure. In some embodiments, universal meter box hub 100 may be securely attached to an enclosure via flanged portion 120 using one or more techniques described herein and/or using any other now known or future developed fastening technique.

In various embodiments, engaging body portion 122 of universal meter box hub 100 may include a threaded portion 202. In some embodiments, the threaded portion 202 may be located (or begin) proximate or adjacent to an outer edge 105 of engaging body portion 120. In some embodiments, threaded portion 202 may extend axially and inwardly from outer edge 105 of universal meter box hub 100. In some embodiments, the threaded portion 202 of engaging body portion 122 may be located along an interior cavity of opening 200 formed by side walls 124. In some embodiments, engaging body portion 122 may also (or instead) include a threaded portion 202 located on the outside of engaging body portion 122 (and side walls 124).

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A hub for use with meter boxes having different layouts of pre-drilled holes, the hub comprising:
a base with a flanged portion configured to be placed against an outer surface of an enclosure having a set of holes arranged in one of two or more layouts; and
an engaging body portion formed of side walls extending away from the flanged portion,
wherein an interior surface of the side walls defines an opening via which the hub is configured to receive a conduit at an end of the engaging body portion opposite the base,
wherein the interior surface includes a threaded portion configured to engage a reciprocal threaded portion of the conduit, and
wherein the flanged portion includes a plurality of slots configured to receive fasteners to removably attach the hub to the enclosure, wherein the plurality of slots are elongated and arranged to accommodate each of the two or more layouts.

2. The hub of claim 1, wherein the engaging body portion is substantially cylindrical.

3. The hub of claim 1, wherein the threaded portion includes a blunt start thread.

4. The hub of claim 1, wherein an exterior surface of the side walls includes a threaded portion proximate the end of the engaging body portion opposite the base.

5. The hub of claim 1, wherein the base is configured to be placed against a top side of the enclosure.

6. The hub of claim 1, wherein the plurality of slots include at least a first set of slots positioned proximate a first outer edge of the base and a second set of slots positioned proximate a second outer edge of the base.

7. The hub of claim 6, wherein the plurality of slots includes at least four slots, wherein the first set of slots includes two slots, and the second set of slots includes two slots.

8. The hub of claim 7, wherein the first set of slots comprise elongated apertures positioned parallel to each other and the first outer edge of the base, and wherein the second set of slots comprise elongated apertures pointing towards a center of the opening defined by the interior surface of the side walls.

9. A meter box system comprising:
a meter box including at least four apertures arranged in one or more rectangular configurations; and
a hub including:
a centralized aperture for receiving a conduit housing electrical supply wires; and
a means for coupling the hub to the meter box via the at least four apertures.
